(19) United States
(12) Patent Application Publication
(10) Pub. No.: US 2025/0122896 A1
(43) Pub. Date: Apr. 17, 2025

(54) PRESSURE AND FLOW MATCHING CONTROL METHOD OF HYDRAULIC POWER SOURCE FOR ROBOT

(71) Applicant: Yanshan University, Qinhuangdao (CN)

(72) Inventors: Bin Yu, Qinhuangdao (CN); Huashun Li, Qinhuangdao (CN); Chengze Gu, Qinhuangdao (CN); Bohan Zheng, Qinhuangdao (CN); Kaixian Ba, Qinhuangdao (CN); Guoliang Ma, Qinhuangdao (CN); Lipeng Yuan, Qinhuangdao (CN)

(21) Appl. No.: 18/766,659

(22) Filed: Jul. 9, 2024

(30) Foreign Application Priority Data
Oct. 16, 2023 (CN) 2023113359064

(51) Int. Cl. F15B 19/00; B25J 9/14; F15B 1/04; F15B 13/02; G05D 7/06; G05D 16/20

(52) U.S. Cl. CPC F15B 19/007; B25J 9/14; F15B 1/04; F15B 13/02; G05D 7/0635; G05D 16/2066

(57) ABSTRACT

The present disclosure relates to a pressure and flow matching control method of a hydraulic power source for a robot, which includes S1: establishing a mathematical model of key components of the hydraulic power source; S2: constructing a trajectory planning model and kinematic model of the robot based on the mathematical model of the key components of the hydraulic power source; S3: improving a response speed by feedforward compensation and establishing a flow closed-loop control link of the hydraulic power source for the robot; S4: establishing a conversion relationship from the pressure to the flow and achieving the pressure and flow matching control of the hydraulic power source for the robot. The present disclosure completes the trajectory planning and kinematic analysis for the robot, establishes a conversion relationship between the pressure characteristics and the flow characteristics, and achieve the pressure and flow matching control of the hydraulic power source.

### TECHNICAL FIELD

The present disclosure relates to the field of active control for pressure and flow of hydraulic power source, specifically to a controlling method for matching pressure and flow control of a robot hydraulic power source.

### BACKGROUND

The robot hydraulic power source is driven by a prime mover to drive a hydraulic oil pump, convert mechanical energy into pressure energy. By controlling pressure, flow, and flowing direction of fluid in the system through control components, and regulating temperature of the fluid through auxiliary components, the flow in the system is supplemented and the system components are protected. To this end, the fluid outputs energy to the actuating components of the robot's joints.

During the movement of the robot, the hydraulic power source continuously outputs energy to ensure adequate supply of the pressure and the flow, to achieve the load-bearing and mobility performance of the robot. However, the output pressure and the flow of the hydraulic power source are generally designed to be a maximum value required during the movement of the robot, which is higher than actual demand of the robot for most of the time. This results in severe energy loss and waste, reducing endurance of the robot and thereby affecting the motion performance of the robot's joints and the entire machine.

At present, by using components such as a constant pressure variable displacement pump, a constant power hydraulic pump, and a load-sensitive variable displacement pump, a high-efficient hydraulic power source is established; and the control accuracy of the pressure and the flow can be improved through methods such as PID, adaptive control, fuzzy control, and feedforward compensation, the energy waste caused by excessive steady-state output pressure and the flow has been preliminarily reduced. However, it has not solved the energy loss caused by dynamic pressure and flow mismatch due to changes in robot load. At the same time, due to inherent nonlinear and time-varying characteristics of the hydraulic power source system, and coupling characteristics between the output pressure and the flow, the difficulty and challenge of the control method have been further increased.

### SUMMARY

In order to overcome the shortcomings in the prior art, the present disclosure provides a pressure and flow matching control method of a hydraulic power source for a robot, which analyzes and models the hydraulic power source for the robot, completes the trajectory planning and kinematic analysis for the robot, establishes a conversion relationship between the pressure characteristics and the flow characteristics, and achieve the pressure and flow matching control of the hydraulic power source. This can ensure that the pressure and flow are output in match with the actual needs of the robot, and meet the requirements of practical applications.

In order to achieve the above object, the present disclosure discloses the following technical solution:

A pressure and flow matching control method of a hydraulic power source for a robot, includes
S1: establishing a mathematical model of key components of the hydraulic power source; the key components of the hydraulic power source comprising a servo motor, a piston pump, an accumulator, an overflow valve, sensors, pipelines, a servo valve, and an asymmetric cylinder;
S2: constructing a trajectory planning model and kinematic model of the robot based on the mathematical model of the key components of the hydraulic power source in step S1, and determining a real-time pressure and flow characteristics of the hydraulic power source;
S21: analyzing load pressure characteristics of the robot under different gaits and working conditions, calculating a force at joints of the robot through dynamic analysis, and converting it into the pressure required by a hydraulic system at the joints, determining a maximum pressure as the pressure that the hydraulic power source outputs, a calculation formula is as follows:

$${P}_{max} = max \{ {P}_{ai} , {P}_{bi} \} ;$$

wherein pₘₐₓ represents the pressure that the hydraulic power source outputs; Pₐᵢ represents pressure of a rodless chamber; P_{bi} represents pressure of a rod chamber; max represents a function to take a maximum value;
S22: analyzing load flow characteristics of the robot under the different gaits and working conditions; on a robot model, establishing foot trajectories of the robot under the different gaits and working conditions; obtaining working space of the joints of the robot through calculation of the inverse kinematics, and then, extracting velocity of a hydraulic cylinder of each of the joints, measuring actual velocity of the joints of the robot through a displacement sensor on the hydraulic cylinder, and converting it into the flow as desired for the joints; according to the flow output by the hydraulic power source during actual operation of the robot, superimposing a sum of the flows required by the hydraulic cylinders on the joints, and a desired flow determined according to an opening state of the servo valve being as follows:

$${Q}_{d} = \sum \vert {v}_{ra} \vert \times {A}_{pa} + \sum 0 + \sum \vert {v}_{rb} \vert \times {A}_{pb} ;$$

wherein Q_{d} represents the desired flow; vᵣₐ represents a desired speed when a valve opening is positive; v_{rb} represents a desired speed when the valve opening is negative; Aₚₐ represents an area of the rodless chamber of the hydraulic cylinder; A_{pb} represents an area of the rod chamber of the hydraulic cylinder;
S3: improving a response speed by feedforward compensation and establishing a flow closed-loop control link of the hydraulic power source for the robot; based on the real-time flow characteristics of the hydraulic power source obtained in step S22, establishing a flow closed-loop control link, feedbacking flow signals collected by a flow sensor to the controller, and introducing the feedforward compensation to improve the response speed, forming a flow closed-loop control; performing the control according to a flow deviation of the flow closed-loop control, adding the feedforward compensation to reduce a steady-state error, and a transfer function of constructing the flow closed-loop control being as follows:

$$Q = \frac{{G}_{2} ( s ) {G}_{3} ( s ) ( {G}_{PID} ( s ) + {G}_{ff} ( s ) ) {Q}_{d} - {P}_{s} ( s ) {G}_{3} ( s ) \frac{{V}_{p} {K}_{nq}}{2 {πη}_{m}}}{1 + {G}_{2} ( s ) {G}_{3} ( s ) + {G}_{2} ( s ) {G}_{3} ( s ) {G}_{PID} ( s )} ;$$

wherein Q represents an actual flow; G₂(s) represents a second transfer function of the servo motor; G₃(s) represents a third transfer function of the servo motor; G_{PID}(s) represents a transfer function of a PID controller; Q_{d} represents a desired flow; Pₛ(s) represents a complex pressure function; Vₚ represents a hydraulic pump displacement; K_{nq} represents a conversion factor between the rotation speed and the flow; ηₘ represents mechanical efficiency of the hydraulic pump; G_{ff}(s) represents a transfer function of the feedforward compensator;
S4: establishing a conversion relationship from the pressure to the flow and achieving the pressure and flow matching control of the hydraulic power source for the robot; based on the flow closed-loop control link established in Step S3, and according to the real-time pressure characteristics of the hydraulic power source obtained in Step S21, feedbacking closed-loop pressure control deviation signals that are collected by a pressure sensor of the hydraulic system of the robot to a controller, and making flow corrections based on the pressure, a dimensional coefficient for the conversion from the pressure to the flow being as follows:

$${K}_{pq} = \frac{{Q}_{Lmax}}{{P}_{max}} ;$$

wherein K_{pq} represents a conversion coefficient between the pressure and the overflow flow; Q_{Lmax} represents a maximum overflow flow.
S5: based on the conversion coefficient K_{pq} between the pressure and the overflow flow, transforming an impact of the pressure on the output into an impact of the flow on the output, utilizing the transfer function of the flow closed-loop control from Step S3 to achieve the pressure and flow matching control of the hydraulic power source for the robot.

Preferably, the servo motor, the piston pump, the accumulator, the overflow valve, the pipelines, and the servo valve in step S1 are as follows:
the servo motor is a direct current brushless motor, comprising a permanent magnet rotor and a multi-phase AC winding, the servo motor is driven by square waves and three-phase quantities of the motor are transformed into equivalent two-phase quantities in a d-q coordinate system through Clark-Park transformation, a mathematical model is constructed as follows:

$$\{ \begin{matrix}{U}_{d} = {R}_{s} {i}_{d} + \frac{d}{dt} {Ψ}_{d} - {ω}_{e} {Ψ}_{q} \\ {U}_{q} = {R}_{s} {i}_{q} + \frac{d}{dt} {Ψ}_{q} - {ω}_{e} {Ψ}_{d}\end{matrix} ;$$

wherein U_{d} represents a voltage on a d-axis; Rₛ represents an internal resistance of the motor; i_{d} represents a current on the d-axis; Ψ_{d} represents a magnetic flux on the d-axis; ωₑ represents a rotation speed of the motor; Ψ_{q} represents a magnetic flux on a q-axis; U_{q} represents a voltage on the q-axis; i_{q} represents a current on the q-axis; t represents a time parameter;
the piston pump is used for controlling the hydraulic pump, specifically an axial piston pump;
the mathematical model for the outlet flow is constructed as follows:

$${Q}_{p} = \frac{1}{60} {V}_{p} n {η}_{v} ;$$

wherein Qₚ represents an outlet flow of hydraulic pump; vₚ represents a hydraulic pump displacement; n represents a rotational speed of the motor and the hydraulic pump; ηᵥ represents a volumetric efficiency of the hydraulic pump;
the accumulator is a diaphragm-type accumulator, and a mathematical model for a relationship between a pressure of a gas chamber and an initial state is as follows:

$$( {p}_{a\_g} + {p}_{c} ) {( {V}_{a\_t} - {V}_{a\_f} )}^{k} = ( {p}_{a\_pr} + {p}_{c} ) {V}_{a\_t}^{k} ;$$

wherein p_{a_g} represents a pressure of a gas chamber of the accumulator; p_{c} represents an atmospheric pressure; V_{a_t} represents a total volume of the accumulator; V_{a_f} represents a volume of a liquid chamber of the accumulator; p_{a_pr} represents a pre-charge pressure in the gas chamber of the accumulator; k represents an adiabatic coefficient;
a overflow valve is a proportional overflow valve with a pilot valve, and a mathematical model for the dynamic characteristics based on an opening area of a main valve core is as follows:

$$S ( Δ {p}_{v\_ab} ) = \{ \begin{matrix}{S}_{v\_leak} & Δ {p}_{v\_ab} \leq {p}_{v\_set} \\ {S}_{v\_leak} + \frac{{S}_{v\_max} - {S}_{v\_leak}}{{p}_{v\_max} - {p}_{v\_set}} & {p}_{v\_set} \leq Δ {p}_{v\_ab} \leq {p}_{v\_max} \\ {S}_{v\_max} & Δ {p}_{v\_ab} \geq {p}_{v\_max}\end{matrix}$$

wherein Δp_{v_ab} represents a pressure difference on both ends of the overflow valve; S_{v_leak} represents a leakage area of a valve core of the overflow valve; S_{v_max} represents a maximum opening area of the valve core of the overflow valve; p_{v_max} represents a maximum pressure of the overflow valve; p_{v_set} represents a set pressure of the overflow valve; S(Δp_{v_ab}) represents an output of the overflow valve;
a mathematical model for the pipeline is as follows:

$${q}_{p} = {Ce}_{p} \cdot {p}_{p} + \frac{{V}_{p}}{{β}_{e}} \frac{{dp}_{p}}{dt} ;$$

wherein qₚ represents a flow of the pipeline; pₚ represents pressure of the pipeline; Ceₚ represents a leakage coefficient of the pipeline; Vₚ represents a volume of the pipeline; βₑ represents an effective volume elasticity modulus.
a transfer function of the servo valve is simplified as a second-order oscillating link, and the transfer function between the input voltage and the valve core displacement is as follows:

$$\frac{{X}_{v}}{{U}_{g}} = \frac{{K}_{a} {K}_{xv}}{\frac{{s}^{2}}{{ω}^{2}} + \frac{2 ζ}{ω} s + 1} ;$$

wherein Xᵥ represents a complex function of the valve core displacement; U_{g} represents a complex function of the input voltage; s represents a complex frequency domain variable; Kₐ represents a power amplifier gain of the servo valve; Kₓᵥ represents a gain of the servo valve; ζ represents a damping ratio of the servo valve; ω represents a natural frequency of the servo valve.

Preferably, the sensor in step S1 includes a pressure sensor and a flow sensor, the pressure sensor is equivalent to a proportional link, and a mathematical model between a feedback voltage and a hydraulic pressure is as follows:

$$\frac{{U}_{p}}{P} = {K}_{ps} ;$$

wherein Kₚₛ represents a pressure sensor gain; P represents a hydraulic pressure; Uₚ represents the feedback voltage of the pressure sensor;
the flow sensor is a first-order link, and a mathematical model between the feedback voltage and a hydraulic flow is as follows:

$$\frac{{U}_{q}}{{Q}_{v}} = \frac{{K}_{qu}}{0.05 s + 1} ;$$

wherein K_{qu} represents a gain of the flow sensor; Qᵥ represents a complex function of an oil source flow; U_{q} represents a complex function of the feedback voltage of the flow sensor.

Preferably, in step S1, flow equations for an oil intake flow and an intake chamber volume in the rodless chamber and an oil return flow and a return chamber volume in the rod chamber in an asymmetric cylinder are as follows:

$$\{ \begin{matrix}{Q}_{f 1} = {A}_{1} \frac{{dx}_{p}}{dt} + {C}_{im} ( {p}_{1} - {p}_{2} ) + \frac{{V}_{1}}{{β}_{e}} \frac{{dp}_{1}}{dt} \\ {V}_{1} = {V}_{01} + {A}_{1} {x}_{p}\end{matrix} ;$$

$$\{ \begin{matrix}{Q}_{f 2} = {A}_{2} \frac{{dx}_{p}}{dt} + {C}_{im} ( {p}_{1} - {p}_{2} ) + \frac{{V}_{2}}{{β}_{e}} \frac{{dp}_{2}}{dt} \\ {V}_{2} = {V}_{02} + {A}_{2} {x}_{p}\end{matrix} ;$$

wherein Q_{f1} represents the oil intake flow of the rodless chamber; Q_{f2} represents the oil return flow of the rod chamber; A₁ represents an effective area of the rodless chamber in the asymmetric cylinder; A₂ represents an effective area of the rod chamber in the asymmetric cylinder; xₚ represents a piston displacement of the asymmetric cylinder; Cᵢₘ represents an internal leakage coefficient of the asymmetric cylinder; βₑ represents an effective volume elasticity modulus; V₀₁ represents an initial volume of the rodless chamber in the asymmetric cylinder; V₀₂ represents an initial volume of the rod chamber in the asymmetric cylinder; p₁ represents pressure of the rodless chamber; p₂ represents pressure of the rod chamber; V₁ represents a volume of the oil intake chamber of the rodless chamber; V₂ represents a volume of the oil return chamber of the rod chamber;
the asymmetric cylinder is affected by inertial forces, viscous damping forces, elastic forces, and external load forces, so that a balance equation for an output force and a load force of the asymmetric cylinder is as follows:

$${F}_{p} = {A}_{1} {P}_{1} - {A}_{2} {P}_{2} = {m}_{t} \frac{{d}^{2} {x}_{p}}{{dt}^{2}} + {B}_{p} \frac{{dx}_{p}}{dt} + {Kx}_{p} + {F}_{L} + {F}_{f} ;$$

wherein Fₚ represents a load force of the asymmetric cylinder; P₁ represents the pressure in the rodless chamber; P₂ represents the pressure in the rod chamber; mₜ represents a total mass converted to the piston of the asymmetric cylinder; K represents a load stiffness of the asymmetric cylinder; Bₚ represents a damping coefficient of the load and the asymmetric cylinder; F_{f} represents a Coulomb friction force of the load and the asymmetric cylinder; F_{L} represents an arbitrary external load force acting on the piston of the asymmetric cylinder.

Preferably, analyzing load characteristics of the robot under different gaits and working conditions in step S21, obtaining the force exerted by joints of the robot through dynamic calculation and converting it into the pressure required by each of the joints as follows:
wherein based on a virtual model of the robot as a whole, the force at each joint of the robot is determined as:

$${F}_{i} = \frac{d}{dt} ( \frac{\partial L}{\partial {\dot{q}}_{j}} ) - \frac{\partial L}{\partial {q}_{j}} ;$$

wherein Fᵢ represents a ith generalized force of a generalized coordinate; L represents a Lagrangian function; qⱼ represents a jth joint variable;
the force at the joints is transformed into the pressure required at the joints:

$${F}_{i} = {P}_{bi} {A}_{pb} - {P}_{ai} {A}_{pa} ;$$

wherein P represents the pressure in the rodless chamber; P_{bi} represents the pressure in the rod chamber; Aₚₐ represents an area of the rodless chamber; A_{pb} represents an area of the rod chamber.

Preferably, foot trajectories of the robot under different gaits and working conditions in step S22 are established, a working space of each joint of the robot is calculated through inverse kinematics as follows:
wherein based on the virtual model of the robot as a whole, the foot trajectory of the robot is determined as:

$$\{ \begin{matrix}x ( t ) = \frac{S}{2} ( {a}_{3} {t}^{2} + {a}_{2} {t}^{2} + {a}_{1} t + {a}_{0} ) \\ z ( t ) = - {H}_{0} + \frac{H}{2} [ 1 - cos ( \frac{2 π t}{1 - β t} - \frac{2 π t}{1 - β} ) ]\end{matrix} ;$$

wherein x(t) represents a displacement in x direction of the foot; z(t) represents a displacement in z direction of the foot; S represents a step length of the robot; a₀ represents a first constant coefficient; a₁ represents a second constant coefficient; a₂ represents a third constant coefficient; a₃ represents a fourth constant coefficient; H₀ represents a standing height of the robot; H represents a step height; β represents a duty cycle of the gait.
the inverse kinematics of the robot as a whole is given by:

$$\{ \begin{matrix}{θ}_{1} = arctan ( \frac{{}_{4}^{0} {p}_{y}}{{}_{4}^{0} {p}_{x}} ) \\ {θ}_{2} = arcsin ( \frac{- {a}_{3} {S}_{3}}{\sqrt{{}_{4}^{0} {p}_{z}^{2} + ( {}_{4}^{0} {p}_{x} {C}_{1} + {}_{4}^{0} {p}_{y} {S}_{1} - {a}_{1} )}} ) + arctan ( \frac{{}_{4}^{0} {p}_{z}}{{}_{4}^{0} {p}_{x} {C}_{1} + {}_{4}^{0} {p}_{y} {S}_{1} - {a}_{1}} ) \\ {θ}_{3} = arccos ( \frac{{}_{4}^{0} {p}_{z}^{2} + ( {}_{4}^{0} {p}_{x} {C}_{1} + {}_{4}^{0} {p}_{y} {S}_{1} - {a}_{1} )}{2 {a}_{2} {a}_{3}} )\end{matrix} ;$$

wherein θ₁ represents a rotation angle of a first joint; θ₂ represents a rotation angle of a second joint; θ₃ represents a rotation angle of a third joint; ₄⁰Pₓ represents a horizontal coordinate value in a pose transformation matrix; ₄⁰P_{y} represents a vertical coordinate value in a pose transformation matrix; ₄⁰P_{z} represents a vertical coordinate value in a pose transformation matrix; C₁ represents a cosine value of the rotation angle of the first joint θ₁; S₁ represents a sine value of the rotation angle of the first joint θ₁; S₃ represents a sine value of the rotation angle of the third joint θ₃.

Preferably, the flow deviation of the flow closed-loop control in Step S3 is:

$$VQ = {Q}_{d} - {Q}_{r} ;$$

wherein VQ represents the flow deviation of a closed-loop; Q_{d} represents the desired flow; Qᵣ represents an actual output flow.

Preferably, the transfer function of the feedforward compensator in step S3 is as follows:

$${G}_{ff} ( s ) = \frac{( {L}_{q} s + R + 1 ) [ ( {J}_{m} + {J}_{p} ) s + ( {B}_{m} + {B}_{p} ) ] + 1.5 {K}_{ip} {P}_{n} {F}_{lux} {K}_{wn}}{1.5 {K}_{ip} {P}_{n} {F}_{lux} {K}_{wn}} ;$$

wherein G_{ff}(s) represents a transfer function of the feedforward compensation; L_{q} represents a stator inductance of a q-axis; R represents a stator resistance; Jₘ represents a rotational inertia of a servo motor rotor; Jₚ represents a rotational inertia of the hydraulic pump; Bₘ represents a friction damping coefficient of the servo motor; Bₚ represents a rotational damping of the hydraulic pump; Kᵢₚ represents a conversion factor between current and power; Pₙ represents a number of motor pole pairs; Fₗᵤₓ represents a magnetic flux linkage; K_{wn} represents a conversion factor between the rotation speed of a motor and angular velocity.

Preferably, the closed-loop pressure control deviation in Step S4 is:

$$VP = {P}_{d} - {P}_{r} ;$$

wherein VP represents a pressure control deviation; P_{d} represents a desired pressure; Pᵣ represents an actual output pressure.

Compared to the prior art, the present disclosure has following beneficial effects: the real-time demand status of the pressure and flow of the robot as a whole can be determined by the analysis and modeling of the hydraulic power source for the robot and based on the trajectory planning and kinematic analysis of the robot; through the feedforward compensation of the flow closed-loop control, the matching degree between the flow output of the hydraulic power source and the demand of the robot as a whole can be enhanced, the energy consumption caused by excessive flow can be reduced, and the flow control precision can be improved; by establishing the conversion and compensation function of the pressure characteristics and the flow characteristics based on the pressure closed-loop control, forming the pressure and flow matching control method of the hydraulic power source, the stable pressure can be achieved while meeting the arbitrary flow output, to provide the stable pressure and the sufficient flow required by the robot as a whole with under various gaits, and meanwhile the pressure and flow output can be ensured to be in match with the actual needs of the robot, thereby reducing energy waste.

### BRIEF DESCRIPTION OF THE DRAWINGS

FIG. 1 is a control method for matching flowchart of pressure and flow of a robot hydraulic power source according to the present disclosure;

FIG. 2 is a schematic view of the hydraulic power source according to the present disclosure;

FIG. 3 is a closed-loop control view of the flow of the hydraulic power source according to the present disclosure;

FIG. 4 is a matching control view of pressure and the flow of the hydraulic power source according to the present disclosure;

FIG. 5 is a sensor-based corrected matching control view of the pressure and the flow of the hydraulic power source according to the present disclosure;

FIG. 6 is a matching control sine response curve diagram of the pressure and the flow of the hydraulic power source according to the present disclosure;

FIG. 7 is a matching control gait response curve diagram of the pressure and flow of the hydraulic power source according to the present disclosure;

FIG. 8 is a matching control effect diagram of the pressure and the flow of the hydraulic power source of the present disclosure.

### DETAILED DESCRIPTION

Exemplary embodiments, features and aspects of the present disclosure will be described in detail below with reference to the accompanying drawings. Same reference numbers denote elements with the same or similar functions in the figures. Although various aspects of embodiments are shown in the drawings and are not necessarily drawn to scale, unless otherwise specified.

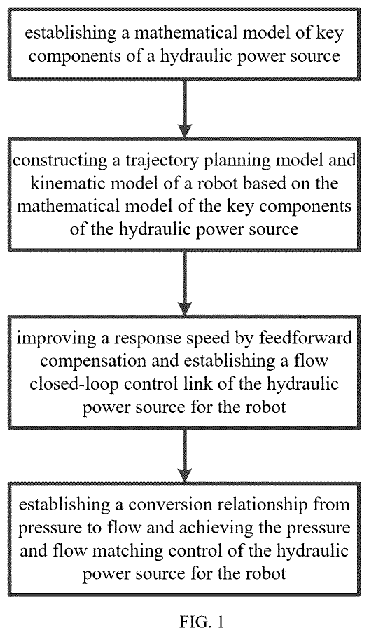

The present disclosure provides a pressure and flow matching control method of a hydraulic power source for a robot. As shown in FIG. 1, it is a flowchart of the pressure and the flow matching control method of the hydraulic power source for the robot according to the present disclosure. A mathematical model of key components of the hydraulic power source is established. Based on the mathematical model of the key components of the hydraulic power source, a robot trajectory planning model and a kinematic model are constructed to determine the real-time pressure and flow characteristics of the hydraulic power source. Feedforward compensation is used to improve response speed, a closed-loop flow control link for the robot hydraulic power source is established, a conversion relationship from the pressure to the flow is established, and the matching control of the pressure and the flow of the robot hydraulic power source is realized, which includes:

Step S1: establishing a mathematical model of the key components of the hydraulic power source.

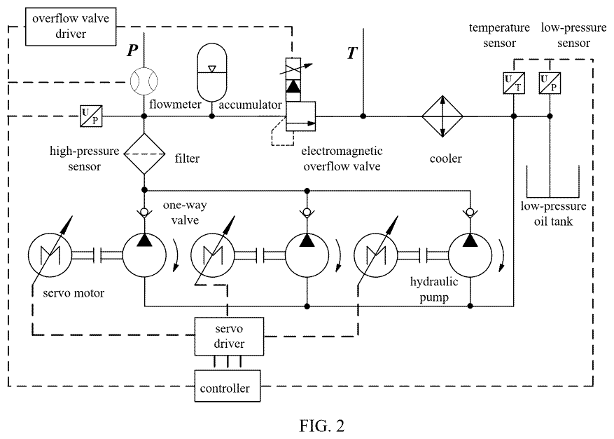

As shown in FIG. 2, it is a schematic diagram of the hydraulic power source of the present disclosure. The motor drives the pump to rotate, causing hydraulic oil with certain pressure and flow characteristics to enter different valve-controlled cylinders through an integrated valve block from filters, high-pressure sensors, and flow sensors.

An accumulator is used to supplement instantaneous flow, and AN overflow valve serves as a safety valve to protect the circuit; the mathematical model of the key components of the hydraulic power source consists of a servo motor, a piston pump, an accumulator, an overflow valve, a sensor, pipelines, a servo valve, and an asymmetric cylinder.

In an embodiment of the present disclosure, the servo motor is a direct current brushless motor, composed of a permanent magnet rotor and a multi-phase AC winding, driven by square waves, and a three-phase quantity of the motor is converted into an equivalent two-phase quantity in the d-q coordinate system through Clark-Park transformation. The mathematical model is constructed as follows:

$$\{ \begin{matrix}{U}_{d} = {R}_{s} {i}_{d} + \frac{d}{d t} {Ψ}_{d} - {ω}_{e} {Ψ}_{q} \\ {U}_{q} = {R}_{s} {i}_{q} + \frac{d}{d t} {Ψ}_{q} + {ω}_{e} {Ψ}_{d}\end{matrix} ;$$

Wherein U_{d} represents d coordinate axis voltage; Rₛ represents a motor internal resistance; i_{d} represents d coordinate axis current; Ψ_{d} represents d coordinate axis magnetic flux; ωₑ represents a motor rotational speed; represents q coordinate axis magnetic flux; U_{q} represents q coordinate axis voltage; i_{q} represents q coordinate axis current; t represents a time parameter,

In the embodiment of the present disclosure, the piston pump is used for hydraulic pump control, specifically an axial piston pump, establishes a mathematical model for an outlet flow as:

$${Q}_{p} = \frac{1}{60} {V}_{p} n {η}_{v} ;$$

Wherein Qₚ represents a hydraulic pump outlet flow; Vₚ represents a hydraulic pump displacement; n represents rotational speed of the motor and the hydraulic pump; ηᵥ represents a volumetric efficiency of the hydraulic pump.

In the embodiment of the present disclosure, a diaphragm-type accumulator is selected, and the mathematical model for the relationship between a gas chamber pressure and an initial state is:

$$( {p}_{a \_ g} + {p}_{c} ) {( {V}_{a \_ t} - {V}_{a \_ f} )}^{k} = ( {p}_{a \_ pr} + {p}_{c} ) {V}_{a \_ t}^{k} ;$$

wherein P_{a_g} represents gas chamber pressure of an accumulator; p_{c} represents an atmospheric pressure; V_{a_t} represents a total volume of the accumulator; V_{a_f} represents a liquid chamber volume of the accumulator; p_{a_pr} represents a gas chamber pre-charge pressure of the accumulator; k represents an adiabatic coefficient.

In the embodiment of the present disclosure, a overflow valve selected is a proportional overflow valve with a pilot valve, and the mathematical model for the dynamic characteristics based on a main valve core opening area is:

$$S ( Δ {p}_{v \_ ab} ) = \{ \begin{matrix}{S}_{v \_ leak} & Δ {p}_{v \_ set} \leq {p}_{v \_ set} \\ {S}_{v \_ leak} + \frac{{S}_{v \_ max} - {S}_{v \_ leak}}{{p}_{v \_ max} - {p}_{v \_ set}} ( Δ {p}_{v \_ ab} - {p}_{v \_ set} ) & {p}_{v \_ set} \leq {p}_{v \_ ab} \leq {p}_{v \_ max} \\ {S}_{v \_ max} & Δ {p}_{v \_ ab} \geq {p}_{v \_ max}\end{matrix} ;$$

wherein Δp_{v_ab} represents a pressure difference on both ends of the overflow valve; S_{v_leak} represents a leakage area of a valve core of the overflow valve; S_{v_max} represents a maximum opening area of the valve core of the overflow valve; p_{v_max} represents a maximum pressure of the overflow valve; p_{v_set} represents a set pressure of the overflow valve; S(Δp_{v_ab}) represents output of the overflow valve.

In the embodiment of the present disclosure, the mathematical model of the pipeline is:

$${q}_{p} = {Ce}_{p} \cdot {p}_{p} + \frac{{V}_{p}}{{β}_{e}} \frac{{dp}_{p}}{dt} ;$$

wherein qₚ represents a pipeline flow; pₚ represents a pipeline pressure; Ceₚ represents a pipeline leakage coefficient; Vₚ represents a pipeline volume; βₑ represents an effective volume elasticity modulus.

In the embodiment of the present disclosure, transfer function of a servo valve is simplified to a second-order oscillatory link, and the transfer function of an input voltage and a valve core displacement of is:

$$\frac{{X}_{v}}{{U}_{g}} = \frac{{K}_{a} {K}_{x v}}{\frac{{s}^{2}}{{ω}^{2}} + \frac{2 ζ}{ω} s + 1} ;$$

wherein Xᵥ represents a complex function of the valve core displacement; U_{g} represents a complex function of the input voltage; s represents a complex frequency domain variable; Kₐ represents a power amplifier gain of the servo valve; Kₓᵥ represents a gain of the servo valve; ζ represents a damping ratio of the servo valve; ω represents a natural frequency of the servo valve.

In the embodiment of the present disclosure, the pressure sensor is equivalent to a proportional link, and a mathematical model between a feedback voltage and a hydraulic pressure is:

$$\frac{{U}_{p}}{P} = {K}_{ps} ;$$

where Kₚₛ represents a gain of a pressure sensor; P represents a hydraulic pressure; Uₚ represents a feedback voltage of the pressure sensor.

In the embodiment of the present disclosure, the flow sensor is a first-order link, and the mathematical model between the feedback voltage and the hydraulic flow is:

$$\frac{{U}_{q}}{{Q}_{v}} = \frac{{K}_{qu}}{005 s + 1} ;$$

where K_{qu} represents a gain of a flow sensor; Qᵥ represents a complex function of the hydraulic flow; U_{q} represents a complex function of the feedback voltage of the flow sensor.

In the embodiment of the present disclosure, flow equations for the asymmetric cylinder, which are an oil intake flow and an intake chamber volume of a rodless chamber and an oil return flow and a return chamber volume of a rod chamber, are respectively:

$$\{ \begin{matrix}{Q}_{f 1} = {A}_{1} \frac{d {x}_{p}}{d t} + {C}_{im} ( {p}_{1} - {p}_{2} ) + \frac{{V}_{1}}{{β}_{e}} \frac{{dp}_{1}}{d t} \\ {V}_{1} = {V}_{01} + {A}_{1} {x}_{p}\end{matrix} ; \{ \begin{matrix}{Q}_{f 2} = {A}_{2} \frac{d {x}_{p}}{d t} + {C}_{im} ( {p}_{1} - {p}_{2} ) - \frac{{V}_{2}}{{β}_{e}} \frac{d {p}_{2}}{d t} \\ {V}_{2} = {V}_{02} - {A}_{2} {x}_{p}\end{matrix} ;$$

where Q_{f1} represents an oil intake flow of the rodless chamber; Q_{f2} represents an oil return flow of the rod chamber; A₁ represents an effective area of the rodless chamber of the asymmetric cylinder; A₂ represents an effective area of the rod chamber of the asymmetric cylinder; xₚ represents a piston displacement of the asymmetric cylinder; Cᵢₘ represents an internal leakage coefficient of the asymmetric cylinder; βₑ represents an effective volume elasticity modulus; V₀₁ represents an initial volume of the rodless chamber of the asymmetric cylinder; V₀₂ represents an initial volume of the rod chamber of the asymmetric cylinder; p₁ represents a pressure of the rodless chamber; p₂ represents a pressure of the rod chamber; V₁ represents a volume of the oil intake chamber of the rodless chamber; V₂ represents a volume of the oil return chamber of the rod chamber.

In the embodiment of the present disclosure, the asymmetric cylinder is affected by inertial forces, viscous damping forces, elastic forces, and arbitrary external load forces, etc., so that a balance equation of the output force and a load force of the asymmetric cylinder is:

$${F}_{p} = {A}_{1} {P}_{1} - {A}_{2} {P}_{2} = {m}_{t} \frac{{d}^{2} {x}_{p}}{d {t}^{2}} + {B}_{p} \frac{d {x}_{p}}{d t} + {Kx}_{p} + {F}_{L} + {F}_{f} ;$$

wherein Fₚ represents a load force of the asymmetric cylinder; P₁ represents a pressure of the rodless chamber; P₂ represents a pressure of the rod chamber; mₜ represents a total mass converted to a piston of the asymmetric cylinder; K represents a load stiffness of the asymmetric cylinder; Bₚ represents a damping coefficient of the load and the asymmetric cylinder; F_{f} represents a Coulomb friction force of the load and the asymmetric cylinder; F_{L} represents an arbitrary external load force acting on the piston of the asymmetric cylinder.

Step S2: based on a mathematical model of key components of the hydraulic power source in step S1, constructing a planning model and a kinematic model of the robot's trajectory, in this embodiment, an input speed of the entire robot is 1.2 m/s, and a total load is 0 kg in a diagonal trot gait; analyzing a real-time pressure and flow requirements demanded by the robot from the hydraulic power source, as shown in FIG. 7, for the expected pressure and expected flow.

Step S21: analyzing load pressure characteristics of the robot under different gaits and working conditions, by calculating dynamics, obtaining a force exerted by each joint of the robot and converting it into the pressure required by the hydraulic system of each joint. According to a virtual model of the entire robot, the force exerted by each joint of the robot is determined as:

$${F}_{i} = \frac{d}{d t} ( \frac{\partial L}{\partial {\dot{q}}_{j}} ) - \frac{\partial L}{\partial {q}_{j}} ;$$

where Fᵢ is an ith generalized force of a generalized coordinate, L is a Lagrangian function, and qⱼ is a jth joint variable.
the force exerted by each joint is transformed into the pressure required by each joint:

$${F}_{i} = {P}_{bi} {A}_{pb} - {P}_{ai} {A}_{pa} ;$$

where Pₐᵢ represents a pressure of the rodless chamber; P_{bi} represents a pressure of the rod chamber; Aₚₐ represents an area of the rodless chamber; A_{pb} represents an area of the rod chamber.
the maximum pressure is determined to be the pressure that the hydraulic power source needs to output, and a calculation formula is as follows:

$${P}_{max} = max \{ {P}_{ai} , {P}_{bi} \} ;$$

where pₘₐₓ represents a pressure that the hydraulic power source needs to output; Pₐᵢ represents the pressure of the rodless chamber; P_{bi} represents the pressure of the rod chamber; max represents a function to take the maximum value.

Step S22: analyzing the load flow characteristics of the robot under different gaits and working conditions; on the robot model, establishing foot trajectory under the different gaits and working conditions; by solving through inverse kinematics, obtaining the working space of each joint of the robot. The inverse kinematics solution for the entire robot is as follows:

$$\{ \begin{matrix}{θ}_{1} = arctan ( \frac{\begin{matrix}0 \\ 4\end{matrix} {P}_{y}}{\begin{matrix}0 \\ 4\end{matrix} {P}_{x}} ) \\ {θ}_{2} = arcsin ( \frac{- {a}_{3} {S}_{3}}{\sqrt{\begin{matrix}0 \\ 4\end{matrix} {P}_{𝓏}^{2} + {( \begin{matrix}0 \\ 4\end{matrix} {p}_{x} {C}_{1} + \begin{matrix}0 \\ 4\end{matrix} {p}_{y} {S}_{1} - {a}_{1} )}^{2}}} ) + arctan ( \frac{\begin{matrix}0 \\ 4\end{matrix} {p}_{𝓏}^{2}}{\begin{matrix}0 \\ 4\end{matrix} {p}_{x} {C}_{1} + \begin{matrix}0 \\ 4\end{matrix} {p}_{y} {S}_{1} - {a}_{1}} ) \\ {θ}_{3} = arccos ( \frac{\begin{matrix}0 \\ 4\end{matrix} {p}_{𝓏}^{2} + {( \begin{matrix}0 \\ 4\end{matrix} {p}_{x} {C}_{1} + \begin{matrix}0 \\ 4\end{matrix} {p}_{y} {S}_{1} - {a}_{1} )}^{2} - {a}_{2}^{2} - {a}_{3}^{2}}{2 {a}_{2} {a}_{3}} )\end{matrix} ;$$

wherein θ₁ represents a rotation angle of the first joint; θ₂ represents a rotation angle of the second joint; θ₃ represents a rotation angle of the third joint; ₄⁰Pₓ represents a horizontal coordinate value in a pose transformation matrix; ₄⁰P_{y} represents a vertical coordinate value in a pose transformation matrix; ₄⁰P_{z} represents a vertical coordinate value in a pose transformation matrix; C₁ represents a cosine value of the rotation angle of the first joint θ₁; S₁ represents a sine value of the rotation angle of the first joint θ₁; S₃ represents the sine value of the rotation angle of the third joint θ₃.

Based on the virtual model of the entire robot, the foot trajectory of the robot is determined as:

$$\{ \begin{matrix}x ( t ) = \frac{S}{2} ( {a}_{3} {t}^{3} + {a}_{2} {t}^{2} + {a}_{1} t + {a}_{0} ) \\ 𝓏 ( t ) = - {H}_{0} + \frac{H}{2} [ 1 - cos ( \frac{2 π t}{1 - β t} - \frac{2 π t}{1 - β} ) ]\end{matrix} ;$$

wherein x(t) represents a displacement in a direction of the foot; z(t) represents a displacement in a direction of the foot; S represents a step length of the robot; a₀ represents a first constant coefficient; a₁ represents a second constant coefficient; a₂ represents a third constant coefficient; a₃ represents a fourth constant coefficient; H₀ represents a standing height of the robot; H represents a step height; β represents a duty cycle of the gait.

Then, a velocity of the joint hydraulic cylinders is extracted. An actual velocity of each robot joint is measured by the displacement sensor on the hydraulic cylinder and converted into the required flow for each joint. Based on the output flow of the hydraulic power source during the actual operation of the robot, a sum of the required flows of the hydraulic cylinders on each joint is superimposed. The desired flow, determined according to the opening state of the servo valve, is as follows:

$${Q}_{d} = \sum \vert {v}_{ra} \vert \times {A}_{pa} + \sum 0 + \sum \vert {v}_{rb} \vert \times {A}_{pb} ;$$

wherein Q_{d} represents a desired flow; vᵣₐ represents a desired speed when the valve opening is positive; v_{rb} represents a desired speed when the valve opening is negative; Aₚₐ represents an area of the rodless chamber of the hydraulic cylinder; A_{pb} represents an area of the rod chamber of the hydraulic cylinder.

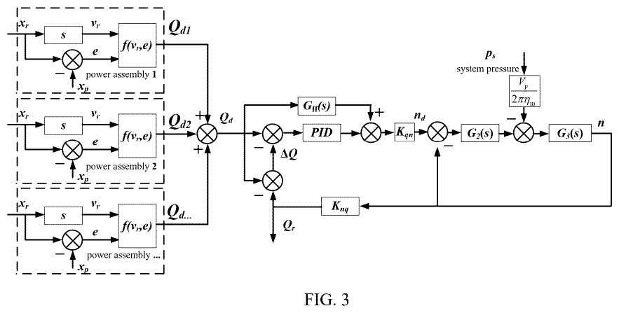

Step S3: Improving a response speed by using feedforward compensation and establishing a flow closed-loop control link for the hydraulic power source of the robot. As shown in FIG. 3, it is a flow closed-loop control block view of the present disclosure; based on the real-time flow characteristics of the hydraulic power source obtained in step S22, a flow closed-loop control link is established, the flow signal collected by the flow sensor is fed back to the controller, and feedforward compensation is introduced to improve the response speed, forming a flow closed-loop control.

A flow deviation of the flow closed-loop control is:

$$VQ = {Q}_{d} - {Q}_{r} ;$$

where VQ represents a closed-loop flow deviation; Q_{d} represents a desired flow; Qᵣ represents an actual output flow.

Controlling is carried out according to the flow deviation of the closed-loop control, and feedforward compensation is added to reduce a steady-state error. A transfer function of the flow closed-loop control is constructed as follows:

$$Q = \frac{{G}_{2} ( s ) {G}_{3} ( s ) ( {G}_{PID} ( s ) + {G}_{ff} ( s ) ) {Q}_{d} - {P}_{s} ( s ) {G}_{3} ( s ) \frac{{V}_{p} {K}_{nq}}{2 {πη}_{m}}}{1 + {G}_{2} ( s ) {G}_{3} ( s ) + {G}_{2} ( s ) {G}_{3} ( s ) {G}_{PID} ( s )} ;$$

where Q represents an actual flow; G₂(s) represents a second transfer function of the servo motor; G₃(s) represents a third transfer function of the servo motor; G_{PID}(s) represents a transfer function of a PID controller; Q_{d} represents a desired flow; Pₛ(s) represents a pressure complex function; vₚ represents a hydraulic pump displacement; K_{nq} represents a conversion factor between the rotation speed and the flow; ηₘ represents a mechanical efficiency of the hydraulic pump; G_{ff}(s) represents a feedforward compensator transfer function.
wherein the feedforward compensation transfer function G_{ff}(s) is:

$${G}_{ff} ( s ) = \frac{( {L}_{q} s + R + 1 ) [ ( {J}_{m} + {J}_{p} ) s + ( {B}_{m} + {B}_{p} ) ] + 1.5 {K}_{ip} {P}_{n} {F}_{lux} {K}_{wn}}{1.5 {K}_{ip} {P}_{n} {F}_{lux} {K}_{wn}} ;$$

wherein G_{ff}(s) represents the feedforward compensation transfer function; L_{q} represents a stator inductance (q-axis); R represents a stator resistance; Jₘ represents a rotational inertia of the servo motor rotor; Jₚ represents a rotational inertia of the hydraulic pump; Bₘ represents a friction damping coefficient of the servo motor; Bₚ represents a rotational damping of the hydraulic pump; Kᵢₚ represents a conversion factor between the current and the power; Pₙ represents the number of motor pole pairs; Fₗᵤₓ represents a magnetic flux linkage; K_{wn} represents a conversion factor between a motor speed and an angular velocity.

A tracking performance of the flow closed-loop control has been significantly improved. At an input frequency of 1.25 Hz and an amplitude of 9 L/min, the maximum error within a cycle is 2.7%, which can greatly reduce the error and enhance the flow sine response performance.

Step S4: establishing the conversion relationship from the pressure to the flow to achieve pressure and flow matching control of the hydraulic power source of the robot.

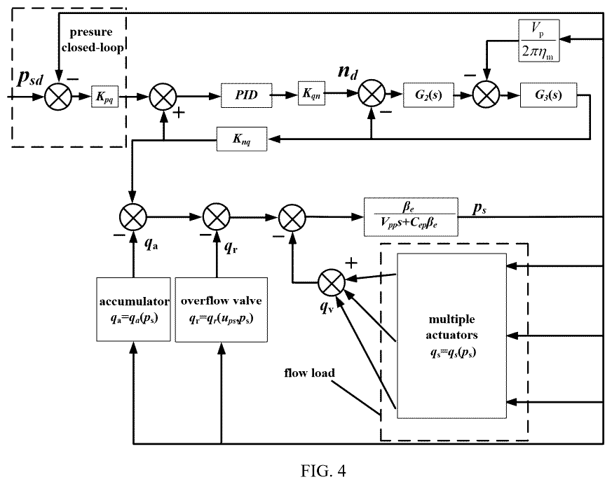

As shown in FIG. 4, it is the hydraulic power source pressure-flow matching control block view of the present disclosure. Based on the flow closed-loop control link in step S3 and the real-time pressure characteristics of the hydraulic power source obtained in step S21, the closed-loop pressure control deviation signal collected by the pressure sensor of the hydraulic system of the robot is fed back to the controller, and flow correction based on pressure is carried out. A dimensional coefficient for the conversion from the pressure to the flow is:

$${K}_{pq} = \frac{{Q}_{Lmax}}{{P}_{max}} ;$$

wherein K_{pq} is a conversion coefficient from the pressure to the overflow flow; Q_{Lmax} is a maximum value of the overflow flow

The closed-loop pressure control deviation is:

$$VP = {P}_{d} - {P}_{r} ;$$

wherein VP is a pressure control deviation; P_{d} is a desired pressure; Pᵣ is an actual output pressure.

With the actual speed of the entire robot at 1.2 m/s and the total load at 0 kg in a diagonal trot gait, the hydraulic power source mathematical model in step S1 is input to obtain the output pressure and the flow of the hydraulic power source, as shown in the actual pressure and the flow at the pump outlet in FIG. 7. To establish the pressure, the flow at the pump outlet is higher than the desired flow, and the pressure also rises rapidly, and the flow at the pump outlet is slightly higher than the desired flow in the subsequent period.

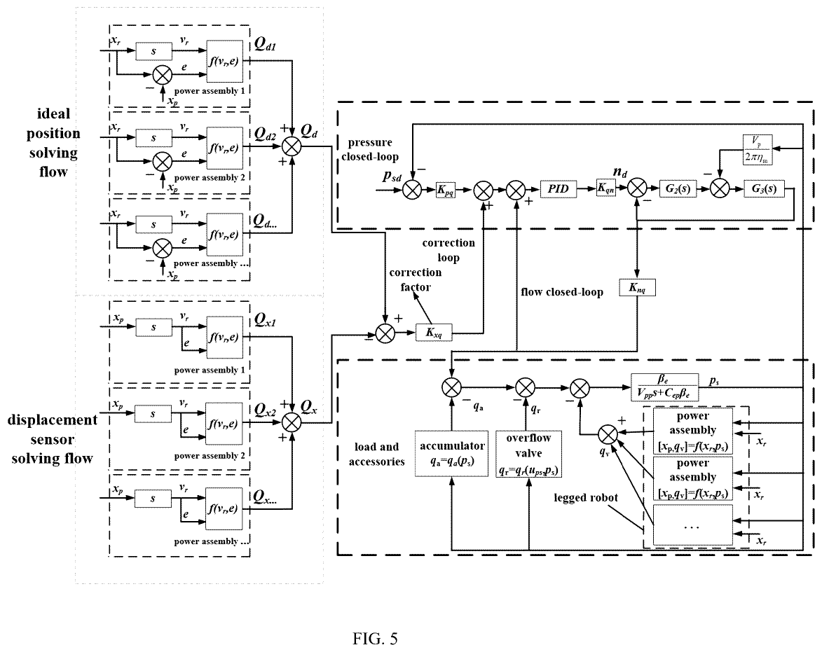

According to the conversion coefficient K_{pq} from the pressure to the overflow flow, the impact of the pressure on the output is converted into the impact of flow on the output. Using the transfer function of the flow closed-loop control in step S3, the pressure and the flow matching control of the hydraulic power source of the robot can be achieved. FIG. 5 shows the hydraulic power source sensor-corrected pressure-flow matching control block view of the present disclosure.

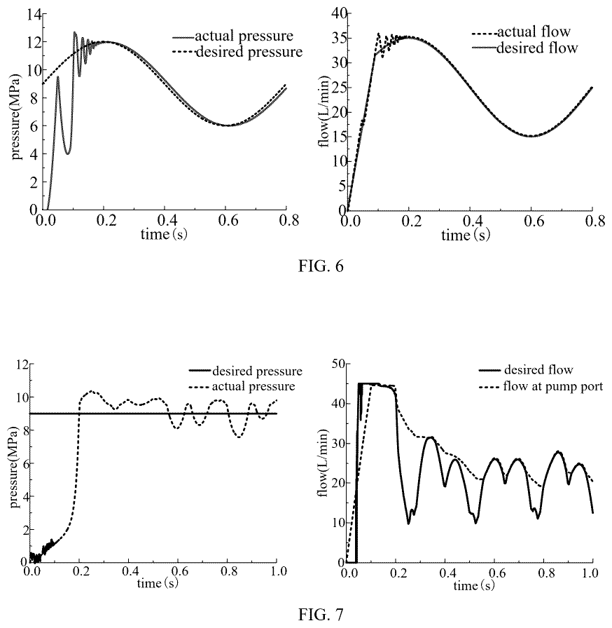

As shown in FIG. 6, it is a hydraulic power source pressure-flow matching control sine response curve diagram of the present disclosure, both the desired pressure and the desired flow are set as sinusoidal signals with an amplitude of 3 MPa and a frequency of 1.25 Hz. The result shows that the response time and the accuracy are presented good by following the actual pressure and the flow output. This proves the effectiveness of the method proposed in the present disclosure under typical signal conditions.

As shown in FIG. 7, it is a hydraulic power source pressure-flow matching control gait response curve diagram of the present disclosure. Both the desired pressure and the desired flow are set as the actual requirements of the robot under typical gait conditions. The result shows that the pressure output can achieve closed-loop stable control, the flow output can meet the flow demand, and the matching degree is high. This proves the effectiveness of the method proposed in the present disclosure under the entire machine gait signal conditions.

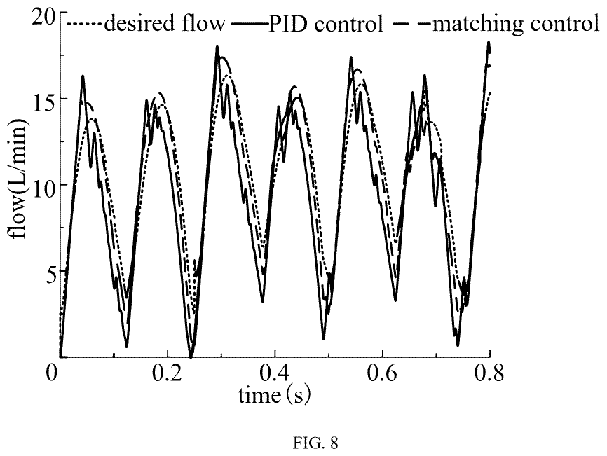

As shown in FIG. 8, it is a hydraulic power source pressure-flow matching control gait response curve diagram of the present disclosure. Both the desired pressure and the desired flow are set as the actual requirements when the robot is in a diagonal trot gait, a motion speed of the robot as a whole is 1 m/s and the load is 0 kg. The results show that compared to the traditional PID control, the present disclosure can significantly improve distortion phenomenon of peaks and troughs, improve the following performance of the flow, enhance the flow response speed, and reduce the errors.

The present disclosure has following advantageous effects: the pressure and flow matching control method of the hydraulic power source for the robot is proposed in the embodiments of the present disclosure, in which analyze and model are performed by the hydraulic power source of the robot, and the real-time demand status of the pressure and the flow of the entire robot are determined based on the trajectory planning and the kinematic analysis of the robot; the flow closed-loop control with the feedforward compensation can enhance a matching degree between the flow output of the hydraulic power source and the demand of the entire robot, reduce the energy consumption caused by excessive flow, and it proves that the flow control accuracy can be improved through the analysis of the embodiments; the pressure characteristic and the flow conversion and the compensation function based on the pressure closed-loop control is established to form the pressure and flow matching control method of the hydraulic power source, which can achieve stable pressure while meeting any flow output, provide the stable pressure and sufficient flow required by the entire robot under various gaits, and make the pressure and flow output in match with the actual demand of the robot, thereby reducing the energy waste, it proves that the actual application effect of this method is better through the embodiments.

The embodiments described above are merely illustrative preferred implementations of the present disclosure rather than limiting the scope of the present disclosure. Various modifications and improvements made by the person skilled in the art to the technical solution of the present disclosure should all fall within the scope of protection determined by the claims of the present disclosure without departing from its spirit of the present disclosure.

What is claimed is:

1. A pressure and flow matching control method of a hydraulic power source for a robot, comprising:
S1: establishing a mathematical model of key components of the hydraulic power source; the key components of the hydraulic power source comprising a servo motor, a piston pump, an accumulator, an overflow valve, sensors, pipelines, a servo valve, and an asymmetric cylinder;
S2: constructing a trajectory planning model and kinematic model of the robot based on the mathematical model of the key components of the hydraulic power source in step S1, and determining a real-time pressure and flow characteristics of the hydraulic power source;
S21: analyzing load pressure characteristics of the robot under different gaits and working conditions, calculating a force at joints of the robot through dynamic analysis, and converting it into the pressure required by a hydraulic system at the joints, determining a maximum pressure as the pressure that the hydraulic power source outputs, a calculation formula is as follows:
$${P}_{max} = max \{ {P}_{ai} , {P}_{bi} \} ;$$
wherein pₘₐₓ represents the pressure that the hydraulic power source outputs; Pₐᵢ represents pressure of a rodless chamber; P_{bi} represents pressure of a rod chamber; max represents a function to take a maximum value;
S22: analyzing load flow characteristics of the robot under the different gaits and working conditions; on a robot model, establishing foot trajectories of the robot under the different gaits and working conditions; obtaining working space of the joints of the robot through calculation of the inverse kinematics, and then, extracting velocity of a hydraulic cylinder of each of the joints, measuring actual velocity of the joints of the robot through a displacement sensor on the hydraulic cylinder, and converting it into the flow as desired for the joints; according to the flow output by the hydraulic power source during actual operation of the robot, superimposing a sum of the flows required by the hydraulic cylinders on the joints, and a desired flow determined according to an opening state of the servo valve being as follows:
$${Q}_{d} = \sum \vert {v}_{ra} \vert \times {A}_{pa} + \sum 0 + \sum \vert {v}_{rb} \vert \times {A}_{pb} ;$$
wherein Q_{d} represents the desired flow; vᵣₐ represents a desired speed when a valve opening is positive; v_{rb} represents a desired speed when the valve opening is negative; Aₚₐ represents an area of the rodless chamber of the hydraulic cylinder; A_{pb} represents an area of the rod chamber of the hydraulic cylinder;
S3: improving a response speed by feedforward compensation and establishing a flow closed-loop control link of the hydraulic power source for the robot; based on the real-time flow characteristics of the hydraulic power source obtained in step S22, establishing a flow closed-loop control link, feedbacking flow signals collected by a flow sensor to the controller, and introducing the feedforward compensation to improve the response speed, forming a flow closed-loop control; performing the control according to a flow deviation of the flow closed-loop control, adding the feedforward compensation to reduce a steady-state error, and a transfer function of constructing the flow closed-loop control being as follows:
$$Q = \frac{{G}_{2} ( s ) {G}_{3} ( s ) ( {G}_{PID} ( s ) + {G}_{ff} ( s ) ) {Q}_{d} - {P}_{s} ( s ) {G}_{3} ( s ) \frac{{V}_{p} {K}_{nq}}{2 {πη}_{m}}}{1 + {G}_{2} ( s ) {G}_{3} ( s ) + {G}_{2} ( s ) {G}_{3} ( s ) {G}_{PID} ( s )} ;$$
wherein Q represents an actual flow; G₂(s) represents a second transfer function of the servo motor; G₃(s) represents a third transfer function of the servo motor; G_{PID}(s) represents a transfer function of a PID controller; Q_{d} represents a desired flow; Pₛ(s) represents a complex pressure function; Vₚ represents a hydraulic pump displacement; K_{nq} represents a conversion factor between the rotation speed and the flow; ηₘ represents mechanical efficiency of the hydraulic pump; G_{ff}(s) represents a transfer function of the feedforward compensator;
the flow deviation of the flow closed-loop control in Step S3 is:
$$VQ = {Q}_{d} - {Q}_{r} ;$$
wherein VQ represents the flow deviation of a closed-loop; Q_{d} represents the desired flow; Qᵣ represents an actual output flow.
the transfer function of the feedforward compensator in step S3 is as follows:
$${G}_{ff} ( s ) = \frac{( {L}_{q} s + R + 1 ) [ ( {J}_{m} + {J}_{p} ) s + ( {B}_{m} + {B}_{p} ) ] + 1.5 {K}_{ip} {P}_{n} {F}_{lux} {K}_{wn}}{1.5 {K}_{ip} {P}_{n} {F}_{lux} {K}_{wn}} ;$$
wherein G_{ff} (s) represents a transfer function of the feedforward compensation; L_{q} represents a stator inductance of a q-axis; R represents a stator resistance; Jₘ represents a rotational inertia of a servo motor rotor; i represents a rotational inertia of the hydraulic pump; Bₘ represents a friction damping coefficient of the servo motor; Bₚ represents a rotational damping of the hydraulic pump; Kᵢₚ represents a conversion factor between current and power; Pₙ represents a number of motor pole pairs; Fₗᵤₓ represents a magnetic flux linkage; K_{wn} represents a conversion factor between the rotation speed of a motor and angular velocity;
S4: establishing a conversion relationship from the pressure to the flow and achieving the pressure and flow matching control of the hydraulic power source for the robot; based on the flow closed-loop control link established in Step S3, and according to the real-time pressure characteristics of the hydraulic power source obtained in Step S21, feedbacking closed-loop pressure control deviation signals that are collected by a pressure sensor of the hydraulic system of the robot to a controller, and making flow corrections based on the pressure, a dimensional coefficient for the conversion from the pressure to the flow being as follows:
$${K}_{pq} = \frac{{Q}_{Lmax}}{{P}_{max}} ;$$
wherein K_{pq} represents a conversion coefficient between the pressure and the overflow flow; Q_{Lmax} represents a maximum overflow flow.
the closed-loop pressure control deviation in Step S4 is:
$$V P = {P}_{d} - {P}_{r} ;$$
wherein VP represents a pressure control deviation; P_{d} represents a desired pressure; Pᵣ represents an actual output pressure;
S5: based on the conversion coefficient K_{pq} between the pressure and the overflow flow, transforming an impact of the pressure on the output into an impact of the flow on the output, utilizing the transfer function of the flow closed-loop control from Step S3 to achieve the pressure and flow matching control of the hydraulic power source for the robot.

2. The pressure and flow matching control method of the hydraulic power source for the robot according to claim 1, wherein the servo motor, the piston pump, the accumulator, the overflow valve, the pipelines, and the servo valve in step S1 are as follows:
the servo motor is a direct current brushless motor, comprising a permanent magnet rotor and a multi-phase AC winding, the servo motor is driven by square waves and three-phase quantities of the motor are transformed into equivalent two-phase quantities in a d-q coordinate system through Clark-Park transformation, a mathematical model is constructed as follows:
$$\{ \begin{matrix}{U}_{d} = {R}_{s} {i}_{d} + \frac{d}{d t} {Ψ}_{d} - {ω}_{e} {Ψ}_{q} \\ {U}_{q} = {R}_{s} {i}_{q} + \frac{d}{d t} {Ψ}_{q} + {ω}_{e} {Ψ}_{d}\end{matrix} ;$$
wherein U_{d} represents a voltage on a d-axis; Rₛ represents an internal resistance of the motor; i_{d} represents a current on the d-axis; Ψ_{d} represents a magnetic flux on the d-axis; ωₑ represents a rotation speed of the motor; Ψ_{q} represents a magnetic flux on a q-axis; U_{q} represents a voltage on the q-axis; i_{q} represents a current on the q-axis; t represents a time parameter;
the piston pump is used for controlling the hydraulic pump, specifically an axial piston pump;
the mathematical model for the outlet flow is constructed as follows:
$${Q}_{p} = \frac{1}{60} {V}_{p} n {η}_{v} ;$$
wherein Qₚ represents an outlet flow of hydraulic pump; Vₚ represents a hydraulic pump displacement; n represents a rotational speed of the motor and the hydraulic pump; ηᵥ represents a volumetric efficiency of the hydraulic pump;
the accumulator is a diaphragm-type accumulator, and a mathematical model for a relationship between a pressure of a gas chamber and an initial state is as follows:
$$( {p}_{a\_g} + {p}_{c} ) {( {V}_{a\_t} - {V}_{a\_f} )}^{k} = ( {p}_{a\_pr} + {p}_{c} ) {V}_{a\_t}^{k} ;$$
wherein P_{a_g} represents a pressure of a gas chamber of the accumulator; p_{c} represents an atmospheric pressure; V_{a_t} represents a total volume of the accumulator; V_{a_f} represents a volume of a liquid chamber of the accumulator; p_{a_pr} represents a pre-charge pressure in the gas chamber of the accumulator; k represents an adiabatic coefficient;
a overflow valve is a proportional overflow valve with a pilot valve, and a mathematical model for the dynamic characteristics based on an opening area of a main valve core is as follows:
$$S ( Δ {p}_{v\_ab} ) = \{ \begin{matrix}{S}_{v\_leak} & Δ {p}_{v\_ab} \leq {p}_{v\_set} \\ {S}_{v\_leak} + \frac{{S}_{v\_max} + {S}_{v\_leak}}{{p}_{v\_max} - {p}_{v\_set}} ( Δ {p}_{v\_ab} - {p}_{v\_set} ) & {p}_{v\_set} \leq Δ {p}_{v\_ab} \leq {p}_{v\_max} \\ {S}_{v\_max} & Δ {p}_{v\_ab} \leq {p}_{v\_max}\end{matrix} ;$$
wherein Δp_{v_ab} represents a pressure difference on both ends of the overflow valve; S_{v_leak} represents a leakage area of a valve core of the overflow valve; S_{v_max} represents a maximum opening area of the valve core of the overflow valve; P_{v_max} represents a maximum pressure of the overflow valve; P_{v_set} represents a set pressure of the overflow valve; S(Δp_{v_ab}) represents an output of the overflow valve;
a mathematical model for the pipeline is as follows:
$${q}_{p} = {Ce}_{p} \cdot {p}_{p} + \frac{{V}_{p}}{{β}_{e}} \frac{{dp}_{p}}{dt} ;$$
wherein qₚ represents a flow of the pipeline; pₚ represents pressure of the pipeline; Ceₚ represents a leakage coefficient of the pipeline; Vₚ represents a volume of the pipeline; βₑ represents an effective volume elasticity modulus.
a transfer function of the servo valve is simplified as a second-order oscillating link, and the transfer function between the input voltage and the valve core displacement is as follows:
$$\frac{{X}_{v}}{{U}_{g}} = \frac{{K}_{a} {K}_{x v}}{\frac{{s}^{2}}{{ω}^{2}} + \frac{2 ζ}{ω} s + 1} ;$$
wherein Xᵥ represents a complex function of the valve core displacement; U^{g} represents a complex function of the input voltage; s represents a complex frequency domain variable; Kₐ represents a power amplifier gain of the servo valve; Kₓᵥ represents a gain of the servo valve; ζ represents a damping ratio of the servo valve; ω represents a natural frequency of the servo valve.

3. The pressure and flow matching control method of the hydraulic power source for the robot according to claim 1, wherein the sensor in step S1 comprises a pressure sensor and a flow sensor,
the pressure sensor is equivalent to a proportional link, and a mathematical model between a feedback voltage and a hydraulic pressure is as follows:
$$\frac{{U}_{p}}{P} = {K}_{p s} ;$$
wherein Kₚₛ represents a pressure sensor gain; P represents a hydraulic pressure; Uₚ represents the feedback voltage of the pressure sensor;
the flow sensor is a first-order link, and a mathematical model between the feedback voltage and a hydraulic flow is as follows:
$$\frac{{U}_{q}}{{Q}_{v}} = \frac{{K}_{q u}}{0.05 s + 1} ;$$
wherein K_{qu} represents a gain of the flow sensor; Qᵥ represents a complex function of an oil source flow; U_{q} represents a complex function of the feedback voltage of the flow sensor.

4. The pressure and flow matching control method of the hydraulic power source for the robot according to claim 1, wherein in step S1, flow equations for an oil intake flow and an intake chamber volume in the rodless chamber and an oil return flow and a return chamber volume in the rod chamber in an asymmetric cylinder are as follows:
$$\{ \begin{matrix}{Q}_{f 1} = {A}_{1} \frac{d {x}_{p}}{d t} + {C}_{im} ( {p}_{1} - {p}_{2} ) + \frac{{V}_{1}}{{β}_{e}} \frac{{dp}_{1}}{d t} \\ {V}_{1} = {V}_{01} + {A}_{1} {x}_{p}\end{matrix} ;$$
$$\{ \begin{matrix}{Q}_{f 2} = {A}_{2} \frac{d {x}_{p}}{d t} + {C}_{im} ( {p}_{1} - {p}_{2} ) - \frac{{V}_{2}}{{β}_{e}} \frac{d {p}_{2}}{d t} \\ {V}_{2} = {V}_{02} - {A}_{2} {x}_{p}\end{matrix} ;$$
wherein Q_{f1} represents the oil intake flow of the rodless chamber; Q_{f2} represents the oil return flow of the rod chamber; A₁ represents an effective area of the rodless chamber in the asymmetric cylinder; A₂ represents an effective area of the rod chamber in the asymmetric cylinder; xₚ represents a piston displacement of the asymmetric cylinder; Cᵢₘ represents an internal leakage coefficient of the asymmetric cylinder; βₑ represents an effective volume elasticity modulus; V₀₁ represents an initial volume of the rodless chamber in the asymmetric cylinder; V₀₂ represents an initial volume of the rod chamber in the asymmetric cylinder; p₁ represents pressure of the rodless chamber; p₂ represents pressure of the rod chamber; V₁ represents a volume of the oil intake chamber of the rodless chamber; V₂ represents a volume of the oil return chamber of the rod chamber;
the asymmetric cylinder is affected by inertial forces, viscous damping forces, elastic forces, and external load forces, so that a balance equation for an output force and a load force of the asymmetric cylinder is as follows:
$${F}_{p} = {A}_{1} {P}_{1} - {A}_{2} {P}_{2} = {m}_{t} \frac{{d}^{2} {x}_{p}}{d {t}^{2}} + {B}_{p} \frac{d {x}_{p}}{d t} + K {x}_{p} + {F}_{L} + {F}_{f} ;$$
wherein Fₚ represents a load force of the asymmetric cylinder; P₁ represents the pressure in the rodless chamber; P₂ represents the pressure in the rod chamber; mₜ represents a total mass converted to the piston of the asymmetric cylinder; K represents a load stiffness of the asymmetric cylinder; Bₚ represents a damping coefficient of the load and the asymmetric cylinder; F_{f} represents a Coulomb friction force of the load and the asymmetric cylinder; F_{L} represents an arbitrary external load force acting on the piston of the asymmetric cylinder.

5. The pressure and flow matching control method of the hydraulic power source for the robot according to claim 1, whereby analyzing load characteristics of the robot under different gaits and working conditions in step S21, obtaining the force exerted by joints of the robot through dynamic calculation and converting it into the pressure required by each of the joints as follows:
wherein based on a virtual model of the robot as a whole, the force at each joint of the robot is determined as:
$${F}_{i} = \frac{d}{d t} ( \frac{\partial L}{\partial {\dot{q}}_{j}} ) - \frac{\partial L}{\partial {q}_{j}} ;$$
wherein Fᵢ represents a ith generalized force of a generalized coordinate; L represents a Lagrangian function; qⱼ represents a jth joint variable;
the force at the joints is transformed into the pressure required at the joints:
$${F}_{i} = {P}_{bi} {A}_{p b} - {P}_{ai} {A}_{p a} ;$$
wherein Pₐᵢ represents the pressure in the rodless chamber; P_{bi} represents the pressure in the rod chamber; Aₚₐ represents an area of the rodless chamber; A_{pb} represents an area of the rod chamber.

6. The pressure and flow matching control method of the hydraulic power source for the robot according to claim 1, wherein foot trajectories of the robot under different gaits and working conditions in step S22 are established, a working space of each joint of the robot is calculated through inverse kinematics as follows:
wherein based on the virtual model of the robot as a whole, the foot trajectory of the robot is determined as:
$$\{ \begin{matrix}x ( t ) = \frac{S}{2} ( {a}_{3} {t}^{3} + {a}_{2} {t}^{2} + {a}_{1} t + {a}_{0} ) \\ z ( t ) = - {H}_{0} + \frac{H}{2} [ 1 - cos ( \frac{2 π t}{1 - β t} - \frac{2 π t}{1 - β} ) ]\end{matrix} ;$$
wherein x(t) represents a displacement in x direction of the foot; z(t) represents a displacement in z direction of the foot; S represents a step length of the robot; a₀ represents a first constant coefficient; a₁ represents a second constant coefficient; a₂ represents a third constant coefficient; a₃ represents a fourth constant coefficient; H₀ represents a standing height of the robot; H represents a step height; β represents a duty cycle of the gait.
the inverse kinematics of the robot as a whole is given by:
$$\{ \begin{matrix}{θ}_{1} = arc tan ( \frac{{}_{4}^{0} {P}_{y}^{}}{{}_{4}^{0} {P}_{x}^{}} ) \\ {θ}_{2} = arc sin ( \frac{- {a}_{3} {S}_{3}}{\sqrt{{}_{4}^{0} {P}_{z}^{2} + {( {}_{4}^{0} {p}_{x}^{} {C}_{1} + {}_{4}^{0} {p}_{y}^{} {S}_{1} - {a}_{1} )}^{2}}} ) + arc tan ( \frac{{}_{4}^{0} {p}_{z}^{}}{{}_{4}^{0} {p}_{x}^{} {C}_{1} + {}_{4}^{0} {p}_{y}^{} {S}_{1} - {a}_{1}} ) \\ {θ}_{3} = arc cos ( \frac{{}_{4}^{0} {p}_{z}^{2} + {( {}_{4}^{0} {p}_{x}^{} {C}_{1} + {}_{4}^{0} {p}_{y}^{} {S}_{1} - {a}_{1} )}^{2} - {a}_{2}^{2} - {a}_{3}^{2}}{2 {a}_{2} {a}_{3}} )\end{matrix} ;$$
wherein θ₁ represents a rotation angle of a first joint; θ₂ represents a rotation angle of a second joint; θ₃ represents a rotation angle of a third joint; ₄⁰Pₓ represents a horizontal coordinate value in a pose transformation matrix; ₄⁰P_{y} represents a vertical coordinate value in a pose transformation matrix; ₄⁰P_{z} represents a vertical coordinate value in a pose transformation matrix; C₁ represents a cosine value of the rotation angle of the first joint θ₁; S₁ represents a sine value of the rotation angle of the first joint θ₁; S₃ represents a sine value of the rotation angle of the third joint θ₃.
